(19) United States
(12) Patent Application Publication
(10) Pub. No.: US 2010/0269805 A1
(43) Pub. Date: Oct. 28, 2010

(54) EXHAUST GAS SENSOR HEATER DEGRADATION DIAGNOSIS DEVICE

(75) Inventors: Hiroyuki FUKUDA, Chiryu-city (JP); Masahiko Yamaguchi, Obu-city (JP); Tetsuji Mitsuda, Ichinomiya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/766,040

(22) Filed: Apr. 23, 2010

(30) Foreign Application Priority Data
Apr. 23, 2009 (JP) 2009-105727

(51) Int. Cl. F02D 41/00

(52) U.S. Cl. 123/690

(57) ABSTRACT

A switching element is connected between a heater of an oxygen sensor and a ground in series. A voltage sensing resistor is connected in parallel with the switching element and in series with the heater. When the switching element is in a de-energization state, if the heater degrades and a resistance of the heater changes, a heater terminal voltage (potential at middle point between heater and voltage sensing resistor) changes correspondingly. Therefore, when the switching element is in the de-energization state, a heater terminal voltage determination parameter changing in accordance with the heater terminal voltage is sensed, and a degradation determination value corresponding to a battery voltage and temperature of the heater is calculated from a map. The heater terminal voltage determination parameter is compared with the degradation determination value to determine whether the heater has degraded.

### CROSS REFERENCE TO RELATED APPLICATION

This application is based on and incorporates herein by reference Japanese Patent Application No. 2009-105727 filed on Apr. 23, 2009.

### BACKGROUND OF THE INVENTION

1. Field of the Invention

The present invention relates to an exhaust gas sensor heater degradation diagnosis device that diagnoses degradation of a heater heating a sensor element of an exhaust gas sensor provided in an exhaust gas passage of an internal combustion engine.

2. Description of Related Art

In a recent internal combustion engine controlled electronically, an exhaust gas sensor (air-fuel ratio sensor, oxygen sensor or the like) for sensing an air-fuel ratio or a rich/lean state of exhaust gas or the like is provided in an exhaust pipe of the internal combustion engine. Feedback control of a fuel injection quantity and the like is performed to conform the air-fuel ratio of the exhaust gas to a target air-fuel ratio based on an output of the exhaust gas sensor. Generally, sensing accuracy of the exhaust gas sensor is low or sensing is impossible unless temperature of a sensor element increases to activation temperature. Therefore, the sensor element is heated with a heater incorporated in the exhaust gas sensor after a start of the internal combustion engine, thereby promoting the activation of the exhaust gas sensor.

An abnormality diagnosis technology of such the heater of the exhaust gas sensor is described in Patent document 1 (JP-A-H6-213846), for example. According to the technology, an impedance of a sensor element changing in accordance with temperature of the sensor element is sensed while the sensor element is heated with a heater (i.e., during energization state of heater), and abnormality diagnosis of the heater is performed by comparing the impedance of the sensor element with a reference value.

The inventors of the present invention are studying a system shown in FIG. 2, for example. The system shown in FIG. 2 controls energization of a heater 28, which heats a sensor element, by switching on and off a switching element 36 connected between the heater 28 and a ground in series. In the system, a voltage sensing resistor 37 is connected in parallel with the switching element 36 (i.e., in series with heater 28). If the heater 28 degrades and a resistance of the heater 28 changes, a heater terminal voltage (i.e., potential at middle point 46 between heater 28 and voltage sensing resistor 37) changes correspondingly. The system performs degradation diagnosis of the heater 28 based on the heater terminal voltage. However, when the switching element 36 is in an energization state, the potential at the middle point 46 between the heater 28 and the voltage sensing resistor 37 becomes equal to a potential of the ground (0V). Therefore, even if the heater 28 degrades and the resistance of the heater 28 changes, the influence does not appear in the heater terminal voltage (i.e., potential at middle point 46 between heater 28 and voltage sensing resistor 37). Accordingly, there exists a problem that the degradation of the heater 28 cannot be detected even if the heater terminal voltage is evaluated.

### SUMMARY OF THE INVENTION

it is an object of the present invention to provide an exhaust gas sensor heater degradation diagnosis device capable of accurately diagnosing degradation of a heater based on a heater terminal voltage.

According to a first example aspect of the present invention, an exhaust gas sensor heater degradation diagnosis device diagnoses degradation of a heater heating a sensor element of an exhaust gas sensor provided in an exhaust gas passage of an internal combustion engine. The diagnosis device has a battery that supplies an electric power to the heater, a voltage sensing resistor connected in series with the heater, a switching section connected in parallel with the voltage sensing resistor, and a degradation diagnosing section for sensing a potential at a middle point between the heater and the voltage sensing resistor as heater terminal voltage information when the switching section is in a de-energization state and for performing degradation diagnosis of the heater based on the heater terminal voltage information.

In the above-described construction, when the switching section is in the de-energization state (energization stop state), if the heater degrades and the resistance of the heater changes, the heater terminal voltage (i.e., potential at middle point between heater and voltage sensing resistor) changes correspondingly. Therefore, by performing the degradation diagnosis of the heater based on the heater terminal voltage information when the switching section is in the de-energization state, the degradation of the heater can be diagnosed with high accuracy. The present invention is not limited to sensing the potential at the middle point between the heater and the voltage sensing resistor. Alternatively, information correlated with the potential at the middle point between the heater and the voltage sensing resistor (referred to as heater terminal voltage information, hereafter) may be sensed. For example, a voltage provided by dividing the heater terminal voltage with a voltage dividing resistor may be sensed.

In this case, the heater terminal voltage decreases if the voltage of the battery decreases even when the heater has not degraded. Therefore, according to a second example aspect of the present invention, the degradation diagnosing section has a section for changing a determination condition for determining existence or nonexistence of the degradation of the heater in accordance with a voltage of the battery. With such the construction, the appropriate determination condition can be set by changing the determination condition in accordance with the change in the heater terminal voltage occurring in accordance with the voltage of the battery. Thus, the degradation diagnosis accuracy of the heater can be improved. When the determination condition is changed in accordance with the voltage of the battery, a degradation determination value to be compared with the heater terminal voltage information may be changed in accordance with the voltage of the battery. Alternatively, the heater terminal voltage information may be corrected in accordance with the voltage of the battery.

The resistance of the heater changes in accordance with the temperature of the heater due to a temperature characteristic of the heater, whereby the heater terminal voltage changes. Therefore, according to a third example aspect of the present invention, the degradation diagnosing section has a section for changing a determination condition for determining existence or nonexistence of the degradation of the heater in accordance with temperature of the heater. With such the construction, the appropriate determination condition can be set by changing the determination condition in accordance with the change in the heater terminal voltage caused by the change in the resistance of the heater occurring in accordance with the temperature of the heater. Thus, the degradation diagnosis accuracy of the heater can be improved.

According to a fourth example aspect of the present invention, the degradation diagnosing section has a section for prohibiting the degradation diagnosis of the heater when a voltage of the battery changes suddenly at change speed higher than predetermined speed. When the battery voltage changes suddenly, the heater terminal voltage fluctuates suddenly. Therefore, in such the case, it is determined that there is a possibility that the degradation diagnosis accuracy of the heater based on the heater terminal voltage information falls, and the degradation diagnosis of the heater is prohibited. Thus, the fall of the degradation diagnosis accuracy of the heater due to the sudden change in the battery voltage can be prevented.

When an electric load that affects a supplied power of the heater (such as heater of other exhaust gas sensor, purge valve, oil pressure control valve of hydraulic variable valve mechanism or electric motor of electric variable valve mechanism) is in operation, there is a possibility that the supplied power of the heater fluctuates and the heater terminal voltage changes due to the operation of the electric load. Therefore, in such the case, there is a possibility that the degradation diagnosis accuracy of the heater based on the heater terminal voltage information falls.

Therefore, according to a fifth example aspect of the present invention, the degradation diagnosing section has a section for permitting the degradation diagnosis of the heater when an electric load that affects the electric power supplied to the heater is not operating. With such the construction, when the electric load that affects the supplied power of the heater is not in operation, it is determined that the supplied power of the heater stabilizes and the heater terminal voltage stabilizes, and the degradation diagnosis of the heater based on the heater terminal voltage information is permitted. Thus, the degradation diagnosis accuracy of the heater can be improved.

### BRIEF DESCRIPTION OF THE DRAWINGS

Features and advantages of an embodiment will be appreciated, as well as methods of operation and the function of the related parts, from a study of the following detailed description, the appended claims, and the drawings, all of which form a part of this application. In the drawings:

FIG. 1 is a schematic configuration diagram showing an engine control system according to an embodiment of the present invention;

FIG. 2 is a schematic diagram showing a heater degradation diagnosis system according to the embodiment;

FIG. 3 is a flowchart illustrating a processing flow of a heater degradation diagnosis routine according to the embodiment; and

FIG. 4 is a diagram conceptually showing an example of a map of a degradation determination value K according to the embodiment.

### DETAILED DESCRIPTION OF EXAMPLE EMBODIMENT

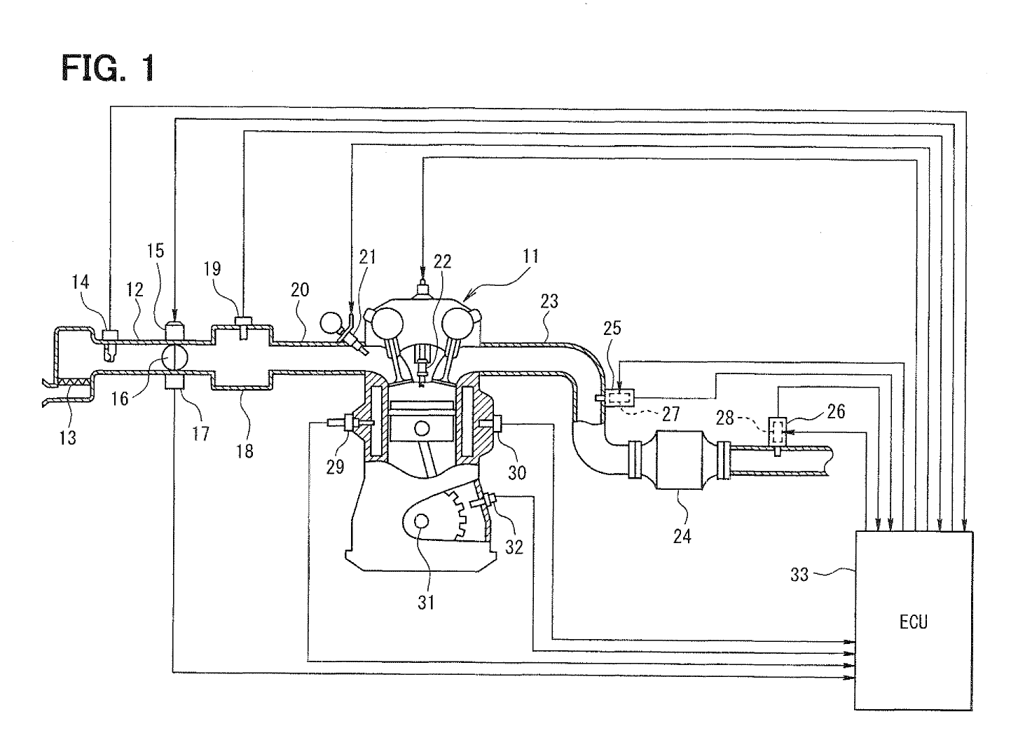

Hereafter, an embodiment of the present invention will be described with reference to the drawings. First, a general configuration of an entire engine control system according to the present embodiment will be explained with reference to FIG. 1. An air cleaner 13 is provided in the most upstream portion of an intake pipe 12 of an engine 11 (internal combustion engine). An airflow meter 14 for sensing an air intake quantity is provided downstream of the air cleaner 13. A throttle valve 16, whose opening degree is regulated by a motor 15, and a throttle position sensor 17 for sensing an opening degree (throttle opening degree, throttle position) of the throttle valve 16 are provided downstream of the airflow meter 14.

A surge tank 18 is provided downstream of the throttle valve 16, and an intake pipe pressure sensor 19 for sensing intake pipe pressure is provided to the surge tank 18. An intake manifold 20 for introducing the air into each cylinder of the engine 11 is provided to the surge tank 18. An injector 21 is attached near an inlet port of the intake manifold 20 of each cylinder. Each injector 21 injects the fuel toward the inlet port. Spark plugs 22 are attached to a cylinder head of the engine 11 for the respective cylinders. Each spark plug 22 ignites a fuel air mixture in the cylinder with a spark discharge from the spark plug 22.

A catalysts 24 such as a three-way catalyst for purifying exhaust gas is provided in an exhaust pipe 23 (exhaust gas passage) of the engine 11. An air-fuel ratio sensor 25 (exhaust gas sensor) that outputs a linear air-fuel ratio signal corresponding to an air-fuel ratio of the exhaust gas is provided upstream of the catalyst 24. An oxygen sensor 26 (exhaust gas sensor), whose output voltage reverses according to whether the air-fuel ratio of the exhaust gas is richer or leaner than the theoretical air-fuel ratio, is provided downstream of the catalyst 24. Heaters 27, 28 for heating sensor elements are incorporated in (or attached to) the air-fuel ratio sensor 25 and the oxygen sensor 26 respectively.

A coolant temperature sensor 29 for sensing coolant temperature and a knock sensor 30 for sensing a knocking vibration are attached to a cylinder block of the engine 11. A crank angle sensor 32 is provided near an outer periphery of a crankshaft 31 and outputs a pulse signal every time the crankshaft 31 rotates by a predetermined crank angle. A crank angle and engine rotation speed are sensed based on the output signal of the crank angle sensor 32.

Outputs of the above various sensors are inputted to an engine control circuit 33 (referred to as ECU, hereinafter). The ECU 33 is constituted mainly by a microcomputer. The ECU 33 executes various kinds of engine control programs stored in an incorporated ROM (storage medium) to control a fuel injection quantity of the injector 21 and ignition timing of the spark plug 22 according to an engine operation state. The ECU 33 performs feedback control of an energization duty (i.e., supplied power) of the heater 27 of the air-fuel ratio sensor 25 and the heater 28 of the oxygen sensor 26 in order to maintain sensor element temperatures of the air-fuel ratio sensor 25 and the oxygen sensor 26 in an active temperature range during an engine operation.

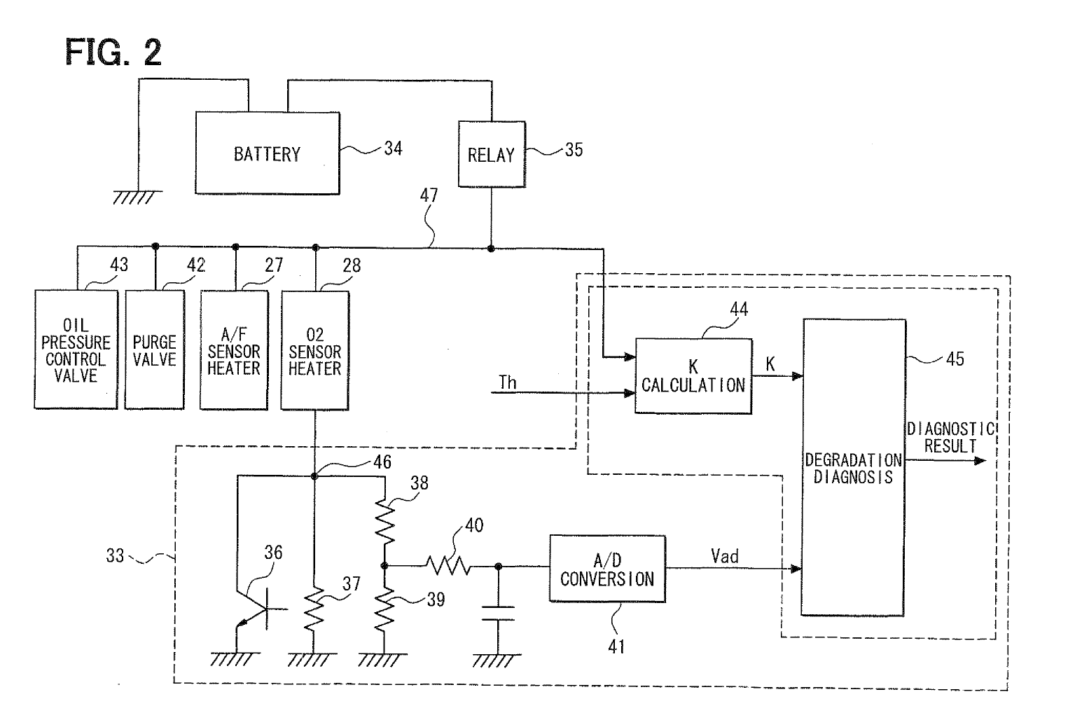

Next, a construction of a heater degradation diagnosis system that diagnoses degradation of the heater 28 of the oxygen sensor 26 will be explained with reference to FIG. 2. The heater 28 of the oxygen sensor 26 is connected to a battery 34 mounted in a vehicle through a relay 35, which is switched on and off by an ignition switch (not shown). A switching element 36 (switching section) is connected between the heater 28 and a ground in series. Energization of the heater 28 is controlled by switching on and off the switching element 36. A voltage sensing resistor 37 is connected in parallel with the switching element 36 (i.e., in series with heater 28). A series circuit of two voltage dividing resistors 38, 39 is connected in parallel with the voltage sensing resistor 37.

When the switching element 36 is in an energization state, a potential at a middle point 46 between the heater 28 and the voltage sensing resistor 37 becomes equal to a potential of the ground (0V). Therefore, even if the heater 28 degrades and the resistance of the heater 28 changes, an influence of the change does not appear in a heater terminal voltage (i.e., potential at middle point 46 between heater 28 and voltage sensing resistor 37).

When the switching element 36 is in a de-energization state (i.e., heater heat generation stop state), if the heater 28 degrades and the resistance of the heater 28 changes, the heater terminal voltage (i.e., potential at middle point 46 between heater 28 and voltage sensing resistor 37) changes correspondingly. Accordingly, a potential at a middle point between the two voltage dividing resistors 38, 39 (i.e., voltage obtained by dividing heater terminal voltage with two voltage dividing resistors 38, 39) changes correspondingly. The potential at the middle point between the voltage dividing resistors 38, 39 is inputted to an A/D conversion section 41 through a resistor 40. An output of the A/D conversion section 41 is sensed as a heater terminal voltage determination parameter Vad (heater terminal voltage information).

The heater 27 of the air-fuel ratio sensor 25, a purge valve 42, an oil pressure control valve 43 of a hydraulic variable valve mechanism (variable valve timing mechanism, variable valve lift mechanism or the like) and the like are connected to a power supply line 47 commonly used by the heater 28 of the oxygen sensor 26. For example, when an exhaust system is divided into two lines in a V-type engine or the like, in addition to the heater 28 of the oxygen sensor 26 (i.e., heater 28 as object of present degradation diagnosis) and the heater 27 of the air-fuel ratio sensor 25 of one of the two exhaust systems, a heater 28 of an oxygen sensor 26 and a heater 27 of an air-fuel ratio sensor 25 of the other one of the exhaust systems are also connected to the common power supply line 47. While these electric loads (electric loads connected to power supply line 47 used by heater 28 in common) are operating, there is a possibility that a power supplied to the heater 28 fluctuates and the heater terminal voltage fluctuates.

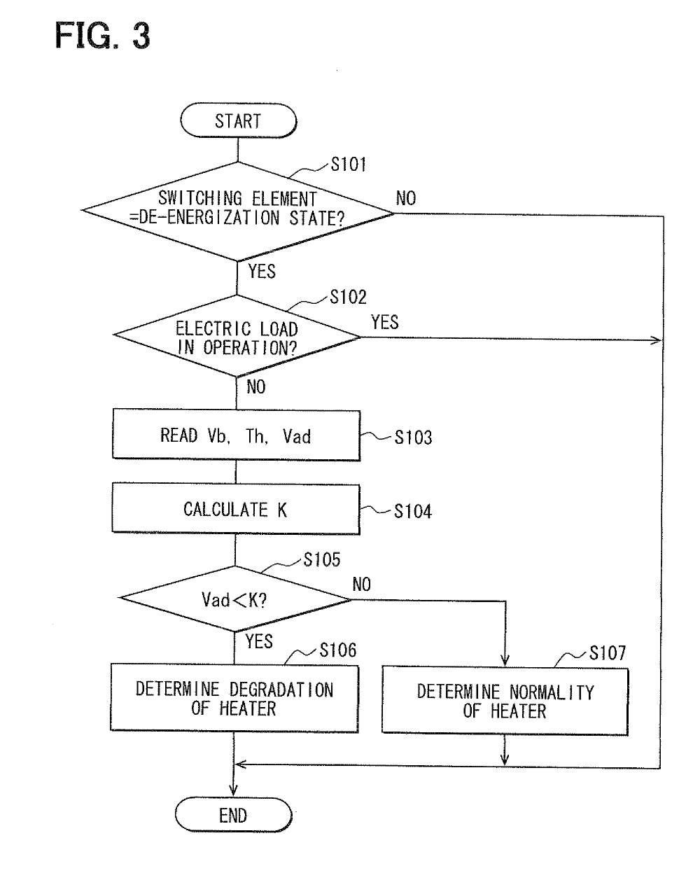

The ECU 33 executes a heater degradation diagnosis routine of FIG. 3 explained in detailed later, thereby realizing functions as a determination value calculation section 44 and a degradation diagnosis section 45. Thus, the ECU 33 performs degradation diagnosis for diagnosing existence/nonexistence of degradation of the heater 28 of the oxygen sensor 26 as follows. The ECU 33 senses the heater terminal voltage determination parameter Vad while the switching element 36 that controls the energization of the heater 28 is in the de-energization state and the electric loads (electric loads connected with power supply line 47 used by heater 28 in common) that affect the supplied power of the heater 28 are not operating. The ECU 33 calculates a degradation determination value K corresponding to a battery voltage Vb (voltage of battery 34) and heater temperature Th (temperature of heater 28) using a map or the like in the determination value calculation section 44. The ECU 33 determines the existence/nonexistence of the degradation of the heater 28 by comparing the heater terminal voltage determination parameter Vad with the degradation determination value K in the degradation diagnosis section 45.

Hereafter, processing contents of the heater degradation diagnosis routine of FIG. 3 executed by the ECU 33 will be explained. The heater degradation diagnosis routine shown in FIG. 3 is executed repeatedly in a predetermined cycle while power supply to the ECU 33 is ON and functions as a degradation diagnosing section. If the routine is started, first in S101 (S means “Step”), it is determined whether the switching element 36 that controls the energization of the heater 28 is in the de-energization state (i.e., heater heat generation stop state). When it is determined in S101 that the switching element 36 is not in the de-energization state, i.e., it is determined that the switching element 36 is in an energization state (i.e., heater heat generation control state), the present routine is ended without performing processing from S102.

When it is determined in S101 that the switching element 36 is in the de-energization state, the processing shifts to S102. In S102, it is determined whether the electric loads that affect the supplied power of the heater 28 are in operation.

The electric loads that affect the supplied power of the heater 28 are electric loads connected to the power supply line 47 commonly used by the heater 28, For example, the electric loads include the heater 27 of the air-fuel ratio sensor 25, the purge valve 42, the oil pressure control valve 43 of the hydraulic variable valve mechanism and the like. If the heater 28 of the oxygen sensor 26 and the heater 27 of the air-fuel ratio sensor 25 of the other one of the exhaust systems are also connected to the common power supply line 47 in addition to the heater 28 of the oxygen sensor 26 (i.e., heater 28 as object of present degradation diagnosis) and the heater 27 of the air-fuel ratio sensor 25 of the one of the exhaust systems, the heater 28 of the oxygen sensor 26 and the heater 27 of the air-fuel ratio sensor 25 of the other one of the exhaust systems also serve as the electric loads that affect the supplied power of the heater 28, which is the object of the present degradation diagnosis. If an electric motor of an electric variable valve mechanism (variable valve timing mechanism, variable lift mechanism or the like) is connected to the common power supply line 47, the electric motor also serves as the electric load that affects the supplied power of the heater 28.

If it is determined in S102 that at least one of the electric loads that affect the supplied power of the heater 28 is in operation (or that total power consumption of electric loads is equal to or greater than predetermined value), there is a possibility that the supplied power of the heater 28 fluctuates and the heater terminal voltage fluctuates. Therefore, in this case, it is determined that there is a possibility that degradation diagnosis accuracy of the heater 28 based on the heater terminal voltage determination parameter Vad falls. In this case, the present routine is ended without performing processing from S103 related to the degradation diagnosis of the heater 28.

If it is determined in S102 that none of the electric loads that affect the supplied power of the heater 28 is in operation (or that total power consumption of electric loads is smaller than predetermined value), it is determined that the supplied power of the heater 28 stabilizes and the heater terminal voltage stabilizes. In this case, the processing from S103 related to the degradation diagnosis of the heater 28 is permitted and performed as follows.

First in S103, the battery voltage Vb and the heater temperature Th are read and the heater terminal voltage determination parameter Vad is read. At that time, the heater temperature Th may be sensed with a temperature sensor. Alternatively, the heater temperature Th may be estimated based on an impedance of the sensor element of the oxygen sensor 26 or the like (information about temperature of sensor element).

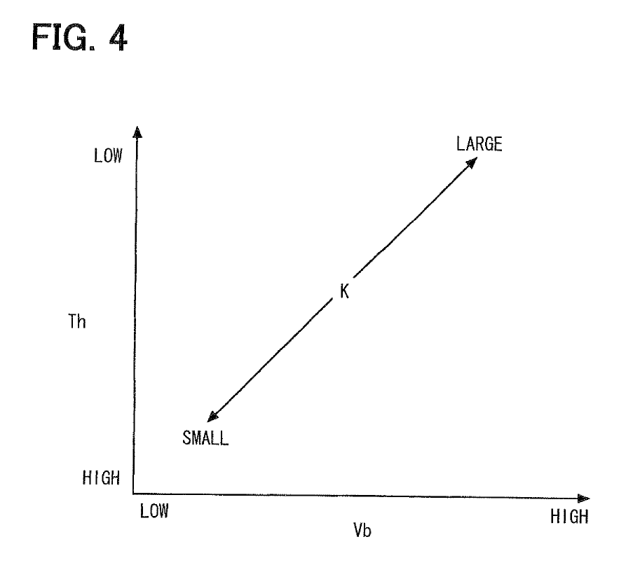

Then, the processing proceeds to S104, in which the degradation determination value K corresponding to the battery voltage Vb and the heater temperature Th is calculated with reference to a map of the degradation determination value K shown in FIG. 4. There are temperature characteristics that the heater terminal voltage increases as the battery voltage Vb increases and that the resistance of the heater 28 increases and the heater terminal voltage decreases as the heater temperature Th increases. Therefore, the map of the degradation determination value K is set such that the degradation determination value K increases as the battery voltage Vb increases and the degradation determination value K decreases as the heater temperature Th increases.

Then, the processing proceeds to S105, in which it is determined whether the heater terminal voltage determination parameter Vad is smaller than the degradation determination value K. As a result, if it is determined that the heater terminal voltage determination parameter Vad is smaller than the degradation determination value K, it is determined that the heater 28 has degraded and the resistance of the heater 28 has become abnormally large. In this case, the processing proceeds to S106, in which it is determined that the degradation of the heater 28 exists. In this case, an abnormality flag is set at ON, and a warning light (not shown) provided in an instrument panel at a driver's seat is lit or an alarm is displayed in an alarm display section (not shown) of the instrument panel to give a warning to the driver. In addition, abnormality information (abnormality code or the like) is stored in a rewritable nonvolatile memory (rewritable storage device that holds stored data even while power supply of ECU 33 is off) such as a backup RAM (not shown) of the ECU 33. Then, the present routine is ended.

If it is determined in S105 that the heater terminal voltage determination parameter Vad is equal to or larger than the degradation determination value K, the processing proceeds to S107. In S107, it is determined that there is no degradation of the heater 28 (i.e., that heater 28 is normal), and the abnormality flag is maintained at OFF. Then, the present routine is ended.

When the switching element 36 is in the de-energization state, if the heater 28 degrades and the resistance of the heater 28 changes, the heater terminal voltage (i.e., potential at middle point 46 between heater 28 and voltage sensing resistor 37) changes correspondingly. In the present embodiment paying attention to this point, the degradation diagnosis of the heater 28 is performed by comparing the heater terminal voltage determination parameter Vad with the degradation determination value K when the switching element 36 is in the de-energization state. Accordingly, the degradation of the heater 28 can be diagnosed with high accuracy.

In the present embodiment, the degradation determination value K is calculated in accordance with the battery voltage Vb and the heater temperature Th. Therefore, the degradation determination value K can be changed in accordance with the change in the heater terminal voltage occurring in accordance with the battery voltage Vb. In addition, the degradation determination value K can be changed in accordance with the change in the heater terminal voltage occurring in accordance with change in the resistance of the heater 28 occurring in accordance with the heater temperature Th. Accordingly, the degradation determination value K can be set at the appropriate value.

Moreover, in the present embodiment, when the electric loads that affect the supplied power of the heater 28 are not operating, it is determined that the supplied power of the heater 28 stabilizes and the heater terminal voltage stabilizes, and the degradation diagnosis of the heater 28 based on the heater terminal voltage determination parameter Vad is permitted. Therefore, the degradation diagnosis accuracy of the heater 28 can be improved.

When the battery voltage changes suddenly at change speed higher than predetermined speed (for example, when change amount of battery voltage per specified time exceeds predetermined value), the heater terminal voltage fluctuates suddenly. Therefore, in such the case, it may be determined that there is a possibility that the degradation diagnosis accuracy of the heater 28 based on the heater terminal voltage determination parameter Vad falls, and the degradation diagnosis of the heater may be prohibited. Thus, the fall of the degradation diagnosis accuracy of the heater 28 due to the sudden change in the battery voltage can be prevented.

In the above-described embodiment, the degradation determination value K is changed in accordance with both of the battery voltage Vb and the heater temperature Th. Alternatively, the degradation determination value K may be changed in accordance with either one of the battery voltage Vb and the heater temperature Th. Alternatively, a determination condition at the time of determining the existence/nonexistence of the degradation of the heater 28 may be changed by correcting the heater terminal voltage determination parameter Vad in accordance with both or either one of the battery voltage Vb and the heater temperature Th.

In the above-described embodiment, the existence/nonexistence of the degradation of the heater 28 is determined based on the heater terminal voltage determination parameter Vad. The method of the degradation diagnosis may be changed arbitrarily. For example, a degradation degree of the heater 28 may be determined based on the heater terminal voltage determination parameter Vad.

In the above-described embodiment, the heater terminal voltage determination parameter Vad that changes in accordance with the heater terminal voltage is sensed, and the degradation diagnosis of the heater 28 is performed based on the heater terminal voltage determination parameter Vad. Alternatively, the heater terminal voltage may be sensed directly and the degradation diagnosis of the heater 28 may be performed based on the heater terminal voltage.

In the above-described embodiment, the present invention is applied to the degradation diagnosis of the heater 28 of the oxygen sensor 26. Alternatively, the present invention may be applied to degradation diagnosis of the heater 27 of the air-fuel ratio sensor 25.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. An exhaust gas sensor heater degradation diagnosis device that diagnoses degradation of a heater heating a sensor element of an exhaust gas sensor provided in an exhaust gas passage of an internal combustion engine, the diagnosis device comprising:
a battery that supplies an electric power to the heater;
a voltage sensing resistor connected in series with the heater;
a switching means connected in parallel with the voltage sensing resistor; and
a degradation diagnosing means for sensing a potential at a middle point between the heater and the voltage sensing resistor as heater terminal voltage information when the switching means is in a de-energization state and for performing degradation diagnosis of the heater based on the heater terminal voltage information.

2. The diagnosis device as in claim 1, wherein
the degradation diagnosing means has a means for changing a determination condition for determining existence or nonexistence of the degradation of the heater in accordance with a voltage of the battery.

3. The diagnosis device as in claim 1, wherein
the degradation diagnosing means has a means for changing a determination condition for determining existence or nonexistence of the degradation of the heater in accordance with temperature of the heater.

4. The diagnosis device as in claim 1, wherein
the degradation diagnosing means has a means for prohibiting the degradation diagnosis of the heater when a voltage of the battery changes suddenly at change speed higher than predetermined speed.

5. The diagnosis device as in claim 1, wherein
the degradation diagnosing means has a means for permitting the degradation diagnosis of the heater when an electric load that affects the electric power supplied to the heater is not operating.
